(19) United States
(12) Patent Application Publication
(10) Pub. No.: US 2026/0204965 A1
(43) Pub. Date: Jul. 16, 2026

(54) METHOD OF MANUFACTURING ROTARY ELECTRIC MACHINE, AND ROTARY ELECTRIC MACHINE

(71) Applicant: NIDEC CORPORATION, Kyoto (JP)

(72) Inventors: Ryoma SASAKI, Kyoto (JP); Shigeru MAEDA, Kyoto (JP); Kentaro HIROSE, Kyoto (JP)

(21) Appl. No.: 18/714,093

(22) PCT Filed: Nov. 1, 2022
(86) PCT No.: PCT/JP2022/040861

§ 371 Date: May 29, 2024

(30) Foreign Application Priority Data
Nov. 30, 2021 (JP) 2021-194790

(51) Int. Cl. H02K 1/278; H02K 1/14; H02K 15/03

(52) U.S. Cl. CPC H02K 1/278; H02K 1/14; H02K 15/03

(57) ABSTRACT

A method of manufacturing a rotary electric machine includes: assembling, to a rotor core extending in an axial direction with a central axis as the center, a plurality of first magnets arranged in a circumferential direction, a plurality of second magnets arranged in the circumferential direction on one side in the axial direction with respect to the first magnets, and a shim made of a non-magnetic material and located between the first magnets and the second magnets; and fixing the first magnets and the second magnets to the rotor core. The magnetization directions of the first magnet and the second magnet are radial directions and are opposite to each other. The magnet fixing is performed in a state where the first magnets and the second magnets are brought into contact with opposite surfaces of the shim respectively by attracting each other with their magnetic force.

### RELATED APPLICATIONS

The present application is a National Phase of International Application No. PCT/JP2022/040861 filed Nov. 1, 2022, which claims priority to Japanese Application No. 2021-194790, filed Nov. 30, 2021.

### TECHNICAL FIELD The present invention relates to a method of manufacturing a rotary electric machine, and a rotary electric machine.

### BACKGROUND ART

Conventionally, a bearing-less motor floating by a magnetic bearing has been known. Patent Literature 1 discloses a radial gap type bearing-less motor in which an active supporting force of a rotor is generated in an axial direction.

### CITATION LIST

### Patent Literature

Patent Literature 1: JP 2014-121098 A

### SUMMARY OF INVENTION

### Technical Problems

In the bearing-less motor of Patent Literature 1, a supporting force for floating the rotor in the axial direction is generated when the stator is energized.

Patent Literature 1 discloses a configuration in which two permanent magnets that are arranged in an axial direction and whose magnetization directions are reversed are used as permanent magnets of a rotor to generate a supporting force in the rotor. As described above, when the permanent magnets whose magnetization directions are reversed are arranged side by side in the axial direction, the permanent magnets attract each other, and thus it is difficult to accurately position the permanent magnets in the fabrication process.

In view of the above circumstances, an object of the present invention is to provide a rotary electric machine in which the positions of magnets of a rotor are easily and accurately aligned.

### Solutions to Problems

One aspect of a method of manufacturing a rotary electric machine of the present invention is a method of manufacturing a rotary electric machine including a rotor centered on a central axis and a stator surrounding the rotor. The method of manufacturing a rotary electric machine 1 includes: an assembling step of assembling, to a rotor core extending in an axial direction with the central axis as the center, a plurality of first magnets arranged in a circumferential direction, a plurality of second magnets arranged in the circumferential direction on one side in the axial direction with respect to the first magnets, and a shim made of a non-magnetic material and located between the first magnets and the second magnets; and a magnet fixing step of fixing the first magnets and the second magnets to the rotor core. The magnetization directions of the first magnet and the second magnet are radial directions and are opposite to each other. The magnet fixing step is performed in a state where the first magnets and the second magnets are brought into contact with opposite surfaces of the shim respectively by attracting each other with their magnetic force.

### Advantageous Effects of Invention

According to one aspect of the present invention, it is possible to provide a rotary electric machine in which the positions of the magnets of a rotor are easily and accurately aligned.

### BRIEF DESCRIPTION OF DRAWINGS

FIG. 1 is a schematic cross-sectional view of a rotary electric machine according to an embodiment.

FIG. 2 is a perspective view illustrating a shaft 11 of a rotary electric machine according to an embodiment.

FIG. 3 is a perspective view illustrating a first spacer insertion step in a method of manufacturing a rotary electric machine according to an embodiment.

FIG. 4 is a perspective view illustrating a rotor core insertion step in a method of manufacturing a rotary electric machine according to an embodiment.

FIG. 5 is a perspective view illustrating a first procedure in a method of manufacturing a rotary electric machine according to an embodiment.

FIG. 6 is a perspective view illustrating a second procedure in a method of manufacturing a rotary electric machine according to an embodiment.

FIG. 7 is a perspective view illustrating a third procedure in a method of manufacturing a rotary electric machine according to an embodiment.

FIG. 8 is a perspective view illustrating a second spacer insertion step in a method of manufacturing a rotary electric machine according to an embodiment.

FIG. 9 is a cross-sectional view taken along line IX-IX of FIG. 8.

### DESCRIPTION OF EMBODIMENT

In the following description, an axial direction of a central axis J, that is, a direction parallel to the vertical direction, is simply referred to as an “axial direction”, a radial direction around the central axis J is simply referred to as a “radial direction”, and a circumferential direction around the central axis J is simply referred to as a “circumferential direction”. In the present embodiment, a lower side (−Z) corresponds to one side in the axial direction, and an upper side (+Z) corresponds to the other side in the axial direction. Note that the vertical direction, the upper side, and the lower side are simply names for describing a relative positional relationship of each portion, and an actual arrangement relationship or the like may be an arrangement relationship other than the arrangement relationships indicated by these names.

### <Rotary Electric Machine>

As illustrated in FIG. 1, a rotary electric machine 1 of the present embodiment includes a rotor 10 centered on the central axis J, a stator 20 surrounding the rotor 10, a pair of magnetic bearings 40, a pair of shoulder bolts 50, a rotation angle sensor 60, a pair of eccentricity sensors 70, a housing 30 accommodating them, and a control unit 90.

In the following description, one of the pair of eccentricity sensors 70 located on the upper side is referred to as an upper eccentricity sensor 70A, and the other located on the lower side is referred to as a lower eccentricity sensor 70B. Similarly, of the pair of shoulder bolts 50, one located on the upper side is referred to as an upper shoulder bolt 50A, and the other located on the lower side is referred to as a lower shoulder bolt 50B. Furthermore, of the pair of magnetic bearings 40, one located on the upper side is referred to as an upper magnetic bearing 40A, and the other located on the lower side is referred to as a lower magnetic bearing 40B. Note that the pair of eccentricity sensors 70 has the same form as each other. The pair of shoulder bolts 50 has the same form as each other. The pair of magnetic bearings 40 has the same form as each other.

(Stator) The stator 20 has an annular shape centered on the central axis J. The rotor 10 is disposed radially inside the stator 20. That is, the stator 20 surrounds the rotor 10 from the radially outer side. The stator 20 includes a plurality of coils 21, a stator core 22, and an insulator (not illustrated).

The stator core 22 is formed of a plurality of electromagnetic steel sheets laminated along the axial direction. The stator core 22 includes a core back portion 23, a plurality of main tooth portions 24a, a plurality of first sub-tooth portions 24b, and a plurality of second sub-tooth portions 24c. The number of slots of the stator 20 of the present embodiment is six. Therefore, the stator 20 of the present embodiment is provided with six main tooth portions 24a, six first sub-tooth portions 24b, and six second sub-tooth portions 24c.

The core back portion 23 has an annular shape centered on the central axis J. An outer peripheral surface of the core back portion 23 is fixed to an inner peripheral surface of the housing 30. The fixing of the core back portion 23 is not necessarily limited to the inner peripheral surface of the housing 30.

The main tooth portion 24a extends radially inward from the inner peripheral surface of the core back portion 23. The plurality of main tooth portions 24a are arranged at equal intervals along the circumferential direction.

The coil 21 is attached to the main tooth portion 24a via an insulating insulator (not illustrated).

The first sub-tooth portion 24b extends radially inward from the inner peripheral surface of the core back portion 23. The plurality of first sub-tooth portions 24b are arranged at equal intervals along the circumferential direction. The first sub-tooth portion 24b is disposed on the upper side (the other side in the axial direction) of the main tooth portion 24a with a gap interposed therebetween. The first sub-tooth portion 24b has the same shape as the main tooth portion 24a as viewed from the axial direction. The first sub-tooth portion 24b overlaps the main tooth portion 24a when viewed from the axial direction.

The second sub-tooth portion 24c extends radially inward from the inner peripheral surface of the core back portion 23. The plurality of second sub-tooth portions 24c are arranged at equal intervals along the circumferential direction. The second sub-tooth portion 24c is disposed on the lower side (one side in the axial direction) of the main tooth portion 24a with a gap interposed therebetween. The second sub-tooth portion 24c has the same shape as the main tooth portion 24a as viewed from the axial direction. The second sub-tooth portion 24c overlaps the main tooth portion 24a when viewed from the axial direction.

The coil 21 is wound around the main tooth portion 24a. The coil 21 has a first coil end 21a and a second coil end 21b. The rotary electric machine of the present embodiment is a three-phase AC motor. Therefore, the number of coils 21 provided to the stator 20 of the present embodiment is a multiple of three. An alternating current whose phase is shifted every 120° flows through the plurality of coils. The number of phases of the coils is not limited to the number in the present embodiment.

The first coil end 21a is a part of the coil 21, and is a portion protruding upward from the upper end surface of the main tooth portion 24a. That is, the first coil end 21a is located on the upper side (the other side in the axial direction) of the main tooth portion 24a. The first coil end 21a is disposed between the upper end surface of the main tooth portion 24a and the lower end surface of the first sub-tooth portion 24b.

The second coil end 21b is a part of the coil 21, and is a portion protruding downward from the lower end surface of the main tooth portion 24a. That is, the second coil end 21b is located on the lower side (one side in the axial direction) of the main tooth portion 24a. The second coil end 21b is disposed between the lower end surface of the main tooth portion 24a and the upper end surface of the second sub-tooth portion 24c.

The main tooth portion 24a functions to generate a magnetic field that is excited by the coil 21 and applies torque to the rotor 10, and also functions to generate a magnetic field that holds the rotor 10 in the axial direction. The first sub-tooth portion 24b and the second sub-tooth portion 24c function to generate a magnetic field that is excited by the coil 21 and holds the rotor 10 in the axial direction.

### (Rotor)

The rotor 10 rotates around the central axis J. The rotor 10 includes a shaft 11, a rotor core 13, a plurality of first magnets 16, a plurality of second magnets 17, a shim 14, a pair of spacers 19, and a pair of magnet pedestal portions 15. The number of the first magnets 16 and the number of the second magnets 17 provided to the rotor 10 are the same.

The shaft 11 has a stepped cylindrical shape extending in the axial direction with the central axis J as the center. The shaft 11 has a rotationally symmetric shape about the central axis J. The shaft 11 includes a large-diameter portion 11a disposed at the center in the axial direction, and small-diameter portions 11b disposed on the upper side and the lower side of the large-diameter portion 11a, respectively. The diameter of the large-diameter portion 11a is larger than the diameter of the small-diameter portion 11b. A stepped surface facing the upper side or the lower side in the axial direction is provided at a boundary portion between the large-diameter portion 11a and the small-diameter portion 11b.

The rotor core 13 is formed of a plurality of electromagnetic steel sheets laminated along the axial direction. The rotor core 13 extends in the axial direction with the central axis J as the center. The rotor core 13 has a cylindrical shape. The rotor core 13 is provided with a through hole 13h extending along the central axis J. The shaft 11 is inserted into the through hole 13h of the rotor core 13.

The rotor core 13 surrounds the large-diameter portion 11a of the shaft 11 from the radially outer side.

The rotor core 13 is bonded and fixed to the outer peripheral surface of the large-diameter portion 11a. The axial dimension of the rotor core 13 is substantially the same as or slightly smaller than the axial dimension of the large-diameter portion 11a. The upper end of the rotor core 13 and the upper end of the large-diameter portion 11a substantially coincide with each other, and the lower end of the rotor core 13 and the lower end of the large-diameter portion 11a substantially coincide with each other.

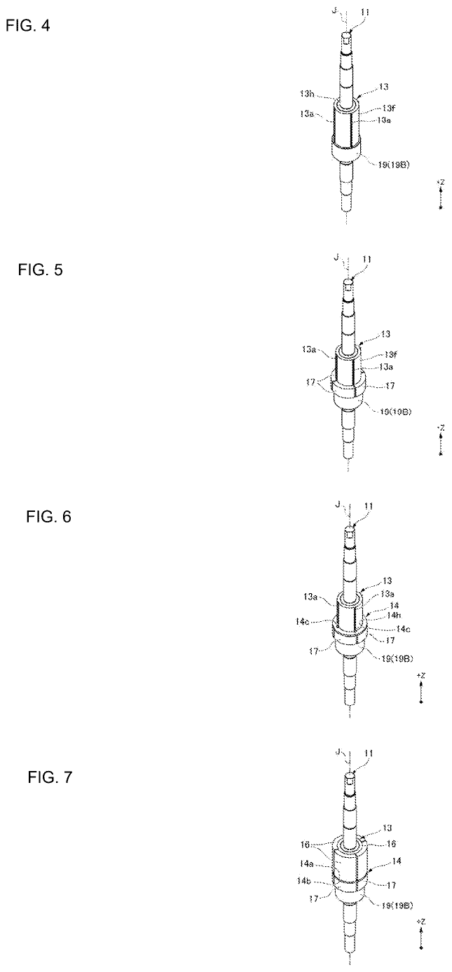

As illustrated in FIG. 4, a plurality of guide portions 13a are provided on the outer peripheral surface 13f of the rotor core 13. The guide portion 13a extends in a rib shape along the axial direction. The guide portion 13a is provided over the entire length in the axial direction of the rotor core 13. Four guide portions 13a of the present embodiment are provided on the outer peripheral surface 13f of the rotor core 13. The four guide portions 13a are arranged at equal intervals in the circumferential direction.

The first magnet 16 is fixed to the outer peripheral surface 13f of the rotor core 13. Each of the first magnets 16 has an arc shape extending along the circumferential direction around the central axis J when viewed from the axial direction. The first magnet 16 has a uniform cross-sectional shape and extends in the axial direction. The inner surface of the first magnet 16 extends along the outer peripheral surface 13f of the rotor core 13. The plurality of first magnets 16 are arranged in the circumferential direction. The rotor 10 of the present embodiment is provided with four first magnets 16. The four first magnets 16 form a single substantially cylindrical shape surrounding the outer peripheral surface 13f of the rotor core 13.

The second magnet 17 is fixed to the outer peripheral surface 13f of the rotor core 13 on the lower side (one side in the axial direction) with respect to the first magnet 16. Each of the second magnets 17 has an arc shape extending along the circumferential direction around the central axis J when viewed from the axial direction. The second magnet 17 has a uniform cross-sectional shape and extends in the axial direction. The inner surface of the second magnet 17 extends along the outer peripheral surface 13f of the rotor core 13. The plurality of second magnets 17 are arranged in the circumferential direction. The rotor 10 of the present embodiment is provided with four second magnets 17. The four second magnets 17 form a single substantially cylindrical shape surrounding the outer peripheral surface 13f of the rotor core 13.

As illustrated in FIG. 9, the guide portion 13a is disposed between the first magnets 16 adjacent to each other in the circumferential direction. Therefore, the first magnets 16 adjacent to each other in the circumferential direction are arranged apart from each other by at least a width dimension along the circumferential direction of the guide portion 13a.

Similarly, the guide portion 13a is disposed between the second magnets 17 adjacent to each other in the circumferential direction. The second magnets 17 adjacent to each other in the circumferential direction are arranged apart from each other by at least a width dimension along the circumferential direction of the guide portion 13a.

According to the present embodiment, the first magnet 16 and the second magnet 17 are arranged between the guide portions 13a adjacent to each other in the circumferential direction. Since the first magnet 16 and the second magnet 17 are formed by sintering or the like, it is difficult to increase the dimensional accuracy. According to the present embodiment, the circumferential positions of the first magnet 16 and the second magnet 17 are defined by the guide portion 13a. Therefore, even when the dimensional tolerance along the circumferential direction of the first magnet 16 and the second magnet 17 is large, it is possible to prevent the circumferential positions of the first magnet 16 and the second magnet 17 from being extremely deviated. In the present embodiment, the plurality of first magnets 16 are arranged side by side with the guide portion 13a interposed therebetween along the circumferential direction. Therefore, the guide portion 13a defines the circumferential positions of the first magnets 16, and can prevent the first magnets 16 arranged in the circumferential direction from extremely approaching each other due to the attraction between the first magnets 16. Similarly, the guide portion 13a defines the circumferential positions of the second magnets 17, and can prevent the second magnets 17 arranged in the circumferential direction from extremely approaching each other due to the attraction between the second magnets 17.

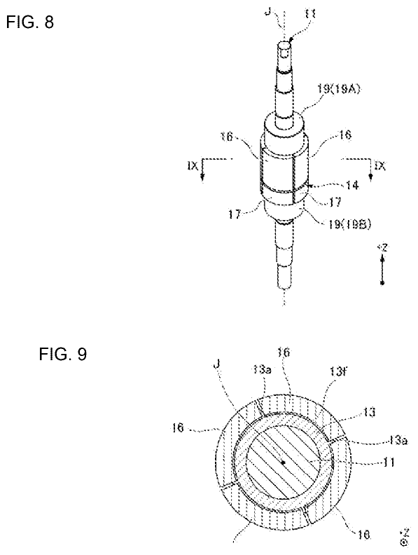

As illustrated in FIG. 8, the plurality of (four in the present embodiment) first magnets 16 and the plurality of (four in the present embodiment) second magnets 17 overlap each other on a one-to-one basis when viewed from the axial direction. The magnetization directions of the first magnet 16 and the second magnet 17 are both radial directions. The magnetization directions of the plurality of first magnets 16 are alternately inverted along the circumferential direction. Similarly, the magnetization directions of the plurality of second magnets 17 are alternately inverted along the circumferential direction.

Furthermore, the magnetization directions of the first magnet 16 and the second magnet 17 arranged in the axial direction are opposite to each other. Therefore, the first magnet 16 and the second magnet 17 attract each other in the axial direction.

As illustrated in FIG. 1, the axial dimension of the first magnet 16 is larger than the axial dimension of the second magnet 17. The first magnet 16 faces the main tooth portion 24a and the first coil end 21a in the radial direction. On the other hand, the second magnet 17 faces the second coil end 21b in the radial direction.

When an alternating current as a field current is caused to flow through the coil 21, a magnetic field that applies torque to the rotor 10 is formed between the stator 20 and the rotor 10. As a result, the stator 20 rotates the rotor 10 about the central axis J.

In addition, when the field current is caused to flow through the coil 21, a magnetic field that supports the rotor 10 in the axial direction is formed between the stator 20 and the rotor 10. More specifically, a magnetic field that attracts the first magnet 16 is generated in the first sub-tooth portion 24b located above the first coil end 21a. Furthermore, a magnetic field that attracts the second magnet 17 is generated in the second sub-tooth portion 24c located below the second coil end 21b. Note that a magnetic field for holding the rotor 10 in the axial direction is also generated in the main tooth portion 24a.

The direction of the current flowing through the first coil end 21a and the direction of the current flowing through the second coil end 21b are opposite directions.

By setting the magnetization directions of the first magnet 16 and the second magnet 17 to be opposite to each other, it is possible to set the directions of the magnetic fields generated around the first coil end 21a and the second coil end 21b to be the same direction, and to generate the supporting force in the same direction in the rotor core 13.

The shim 14 of the present embodiment is a plate material having an annular shape centered on the central axis J and having a plate thickness direction in the axial direction. The shim 14 is made of a non-magnetic material. The shim 14 has a uniform plate thickness. The rotor core 13 is inserted into the shim 14. That is, the shim 14 surrounds the rotor core 13 from the radially outer side.

As illustrated in FIG. 6, a plurality of notches 14c are provided in an inner circumference 14h of the shim 14. The shim 14 of the present embodiment is provided with four notches 14c. The guide portion 13a of the rotor core 13 is disposed inside each of the notches 14c.

As illustrated in FIG. 1, the shim 14 is positioned between the first magnet 16 and the second magnet 17. The shim 14 is sandwiched between the first magnet 16 and the second magnet 17 in the axial direction.

The shim 14 has an upper surface 14a facing upward (the other side in the axial direction) and a lower surface 14b facing downward (one side in the axial direction). The lower surfaces of all the first magnets 16 are in contact with the upper surface 14a. On the other hand, the upper surfaces of all the second magnets 17 are in contact with the lower surface 14b.

As described above, it is difficult to increase the dimensional accuracy of the first magnet 16 and the second magnet 17. Therefore, when the first magnets 16 and the second magnets 17 are arranged around the rotor core 13, the gap dimension between the first magnets 16 and the second magnets 17 tends to be non-uniform along the circumferential direction. If the gap dimension between the first magnets 16 and the second magnets 17 becomes non-uniform along the circumferential direction, there is a possibility that the axial support of the rotor 10 by the stator 20 becomes unstable.

According to the present embodiment, the plurality of first magnets 16 are in contact with the upper surface 14a of the shim 14. Therefore, the lower surfaces of the plurality of first magnets 16 can be arranged on the same plane. Similarly, the plurality of second magnets 17 are in contact with the lower surface 14b of the shim 14.

According to the present embodiment, the upper surfaces of the plurality of second magnets 17 can be arranged on the same plane. Therefore, the gap between the first magnets 16 and the second magnets 17 can be kept constant, and the axial support force applied from the stator 20 to the rotor 10 can be stabilized.

The spacer 19 has a cylindrical shape centered on the central axis J. The spacers 19 are located above and below the rotor core 13, respectively. The spacer 19 is inserted into the shaft 11. In the following description, when the pair of spacers 19 is distinguished, one disposed on the upper side may be referred to as an upper spacer (second spacer) 19A, and the other disposed on the lower side may be referred to as a lower spacer (first spacer) 19B.

The spacers 19 are disposed between the rotor core 13 and the magnet pedestal portion 15 on the upper side and the lower side of the rotor core 13, respectively. The spacers 19 maintain an axial distance between the rotor core 13 and the magnet pedestal portion 15.

A substrate 61 of the rotation angle sensor 60 is disposed radially outside the lower spacer 19B. In the lower spacer 19B, a space in which the substrate 61 is disposed is provided below the rotor core 13 and between the rotor core 13 and the magnet pedestal portion 15 in the axial direction.

The magnet pedestal portion 15 holds an inner magnet 41 of the magnetic bearing 40. The magnet pedestal portion 15 has an annular shape centered on the central axis J.

The magnet pedestal portion 15 is inserted into the shaft 11. The inner peripheral surface of the magnet pedestal portion 15 is fixed to the outer peripheral surface of the shaft 11 with an adhesive or the like. Note that the magnet pedestal portion 15 may be fixed between a nut and a stepped surface of the shaft 11 by inserting the nut into a male screw provided on the shaft 11.

The magnet pedestal portion 15 includes a cylindrical magnet supporting cylindrical portion 15d and a flange portion 15f located at one end of the magnet supporting cylindrical portion 15d. The inner magnet 41 is fixed to the outer peripheral surface of the magnet supporting cylindrical portion 15d with an adhesive or the like. The flange portion 15f is in contact with one surface facing the axial direction of the inner magnet 41. The flange portion 15f positions the inner magnet 41 in the axial direction with respect to the magnet pedestal portion 15.

One of the pair of magnet pedestal portions 15 is located on the upper side of the upper spacer 19A and is in contact with the upper end surface of the upper spacer 19A. The other of the pair of magnet pedestal portions 15 is located on the lower side of the lower spacer 19B and is in contact with the lower end surface of the lower spacer 19B.

Here, one surface in contact with the spacer 19, of the pair of surfaces facing the axial direction of the magnet pedestal portion 15, is referred to as a contact surface 15a, and the other surface facing the opposite side is referred to as a stepped surface 15b. The rotor 10 of the present embodiment has the stepped surface 15b located on the upper side of the first magnet 16 and facing the upper side, and the stepped surface 15b located on the lower side of the second magnet 17 and facing the lower side. As described later, each stepped surface 15b faces the upper shoulder bolt 50A or the lower shoulder bolt 50B.

### (Magnetic Bearing)

The magnetic bearing 40 includes the inner magnet 41 and the outer magnet 42. Each of the inner magnet 41 and the outer magnet 42 has a tubular shape. The inner magnet 41 is fixed to the rotor 10. On the other hand, the outer magnet 42 is fixed to the housing 30. The outer magnet 42 surrounds the inner magnet 41 from the radially outer side. The inner magnet 41 and the outer magnet 42 are each magnetized in the axial direction. The magnetization direction of the inner magnet 41 and the magnetization direction of the outer magnet 42 radially facing the inner magnet 41 coincide with each other.

In the present embodiment, one magnetic bearing 40 is provided with two inner magnets 41 arranged in the axial direction. The magnetization directions of the two inner magnets 41 are inverted from each other. Similarly, one magnetic bearing 40 is provided with two outer magnets 42 arranged in the axial direction, and the magnetization directions of these two outer magnets 42 are inverted from each other. In the present embodiment, the inner magnet 41 and the outer magnet 42 located on the upper side have an S pole on the upper side and an N pole on the lower side, and the inner magnet 41 and the outer magnet 42 located on the lower side have an N pole on the upper side and an S pole on the lower side.

The magnetic bearing 40 holds the rotor 10 rotatably in the radial direction by the inner magnet 41 and the outer magnet 42 repelling each other in the radial direction. As described above, the magnetic bearing 40 of the present embodiment is a passive magnetic bearing that holds the rotor 10 in the radial direction.

The magnetic bearings 40 of the present embodiment are disposed above the first magnet 16 and below the second magnet 17, respectively. As a result, the pair of magnetic bearings 40 can hold the rotor 10 by the double-sided holding structure, so that the rotor 10 can be stably held.

### (Housing)

The housing 30 includes a housing main body 31, an upper magnet holding portion 34, a lower magnet holding portion 37, a pair of shoulder bolt holding portions 35, an upper cover 36, and a lower cover 38.

The upper magnet holding portion 34, the shoulder bolt holding portion 35, and the upper cover 36 are connected to the upper side of the housing main body 31.

On the other hand, the lower magnet holding portion 37, the shoulder bolt holding portion 35, and the lower cover 38 are connected to the lower side of the housing main body 31.

The housing main body 31 has a tubular shape that is open in the vertical direction. The housing main body 31 includes a stator holding portion 31a, an upper connecting portion 31b located above the stator holding portion 31a, and a lower connecting portion 31c located below the stator holding portion 31a.

The stator holding portion 31a has a tubular shape centered on the central axis J. The stator holding portion 31a surrounds the stator core 22 from the radially outer side. Thus, the housing supports the stator 20. The upper magnet holding portion 34 is connected to the upper connecting portion 31b.

The upper magnet holding portion 34 has an annular shape centered on the central axis J. The upper magnet holding portion 34 is screwed to the upper connecting portion 31b of the housing main body 31 from above.

The upper magnet holding portion 34 is provided with a flange housing recess 34p recessed downward from the upper surface, and a magnet holding hole 34h opened on the bottom surface of the flange housing recess 34p. The flange housing recess 34p opens upward. The flange housing recess 34p has a circular shape centered on the central axis J when viewed from the axial direction.

The magnet holding hole 34h of the upper magnet holding portion 34 is a through hole extending in the axial direction with the central axis J as the center. The shaft 11 is inserted into the magnet holding hole 34h. The outer magnet 42 of the upper magnetic bearing 40A is fixed to the inner peripheral surface of the magnet holding hole 34h with an adhesive. Thus, the upper magnet holding portion 34 holds the outer magnet 42. A magnet support surface 34k facing upward is provided on the inner peripheral surface of the magnet holding hole 34h. The magnet support surface 34k is in contact with the lower surface of the outer magnet 42. When the outer magnet 42 comes into contact with the magnet support surface 34k, the outer magnet 42 is positioned in the axial direction with respect to the housing 30.

The lower magnet holding portion 37 has an annular shape centered on the central axis J. The lower magnet holding portion 37 is screwed to the lower connecting portion 31c of the housing main body 31 from below.

The lower magnet holding portion 37 is provided with a flange housing recess 37p recessed upward from the lower surface, and a magnet holding hole 37h opened in the bottom surface of the flange housing recess 37p. The flange housing recess 37p opens downward. The flange housing recess 37p has a circular shape centered on the central axis J when viewed from the axial direction.

The magnet holding hole 37h of the lower magnet holding portion 37 is a through hole extending in the axial direction with the central axis J as the center. The shaft 11 is inserted into the magnet holding hole 37h. The outer magnet 42 of the lower magnetic bearing 40B is fixed to the inner peripheral surface of the magnet holding hole 37h with an adhesive. As a result, the lower magnet holding portion 37 holds the outer magnet 42. A magnet support surface 37k facing downward is provided on the inner peripheral surface of the magnet holding hole 37h. The magnet support surface 37k is in contact with the upper surface of the outer magnet 42. When the outer magnet 42 comes into contact with the magnet support surface 37k, the outer magnet 42 is positioned in the axial direction with respect to the housing 30.

A through hole 30h penetrating radially inward and outward is provided between the lower magnet holding portion 37 and the housing main body 31. Inside the through hole 30h, an extending portion 61b that is a part of the substrate 61 of the rotation angle sensor 60 is disposed.

One of the pair of shoulder bolt holding portions 35 is fixed to the upper magnet holding portion 34, and the other is fixed to the lower magnet holding portion 37. The pair of shoulder bolt holding portions 35 has the same form as each other.

The shoulder bolt holding portion 35 includes a nut portion 35d and a fixed flange portion 35f located at one axial end of the nut portion 35d. The nut portion 35d has a cylindrical shape centered on the central axis J. That is, the nut portion 35d extends in the axial direction with the central axis J as the center. The nut portion 35d has a screw hole 35h in which a female screw is provided on the inner peripheral surface. The shoulder bolt 50 is inserted into the screw hole 35h of the nut portion 35d. Thus, the shoulder bolt holding portion 35 holds the shoulder bolt 50. That is, the shoulder bolt holding portion 35 is held by the housing 30.

In the following description, one of the pair of shoulder bolt holding portions 35 located on the upper side may be referred to as an upper shoulder bolt holding portion 35A, and the other located on the lower side may be referred to as a lower shoulder bolt holding portion 35B.

In the upper shoulder bolt holding portion 35A, the fixed flange portion 35f extends radially outward from the lower end portion of the nut portion 35d. On the other hand, in the lower shoulder bolt holding portion 35B, the fixed flange portion 35f extends radially outward from the upper end portion of the nut portion 35d.

The fixed flange portion 35f of the upper shoulder bolt holding portion 35A is screwed to the upper magnet holding portion 34 from above. That is, the upper shoulder bolt holding portion 35A is fixed to the upper magnet holding portion 34. The fixed flange portion 35f of the upper shoulder bolt holding portion 35A is disposed in the flange housing recess 34p of the upper magnet holding portion 34.

On the other hand, the fixed flange portion 35f of the lower shoulder bolt holding portion 35B is screwed to the lower magnet holding portion 37 from below. That is, the lower shoulder bolt holding portion 35B is fixed to the lower magnet holding portion 37. The fixed flange portion 35f of the lower shoulder bolt holding portion 35B is disposed in the flange housing recess 37p of the lower magnet holding portion 37.

The upper shoulder bolt holding portion 35A covers at least a part of the upper end surface (end surface facing the axial direction) of the outer magnet 42 of the upper magnetic bearing 40A in the fixed flange portion 35f.

Similarly, the lower shoulder bolt holding portion 35B covers at least a part of the lower end surface (end surface facing the axial direction) of the outer magnet 42 of the lower magnetic bearing 40B in the fixed flange portion 35f. Therefore, the upper shoulder bolt holding portion 35A and the lower shoulder bolt holding portion 35B suppress separation of the outer magnet 42 in the axial direction.

The lower surface of the fixed flange portion 35f is provided with a recess 35g that opens in the axial direction. The recess 35g has a bottom surface (gap facing surface) 35b. The bottom surface 35b of the recess 35g faces the inner magnet 41 in the axial direction with a gap interposed therebetween. By providing the recess 35g in the fixed flange portion 35f, a gap is provided between the fixed flange portion 35f and the inner magnet 41, and interference between the fixed flange portion 35f and the inner magnet 41 is suppressed.

The recess 35g has a circular shape centered on the central axis J when viewed from the axial direction. The recess 35g of the upper shoulder bolt holding portion 35A opens downward, and the recess 35g of the lower shoulder bolt holding portion 35B opens upward. The bottom surface 35b of the recess 35g of the upper shoulder bolt holding portion 35A faces downward, and the bottom surface 35b of the recess 35g of the lower shoulder bolt holding portion 35B faces upward. The screw hole 35h of the nut portion 35d is opened in the bottom surface 35b.

The upper cover 36 is located on the upper side of the upper magnet holding portion 34. The upper cover 36 has a cylindrical shape centered on the central axis J.

The upper cover 36 includes an upper cover cylindrical portion 36a, an upper cover bottom portion 36b, and an upper cover flange portion 36f.

The upper cover cylindrical portion 36a has a cylindrical shape extending in the axial direction with the central axis J as the center. The upper cover bottom portion 36b extends radially inward from the upper end of the upper cover cylindrical portion 36a. The upper cover cylindrical portion 36a has a plate shape along a plane orthogonal to the central axis J. A shaft insertion hole 36h through which the shaft 11 is inserted is provided at the center of the upper cover cylindrical portion 36a.

The upper cover flange portion 36f extends radially outward from the lower end of the upper cover cylindrical portion 36a. The upper cover flange portion 36f is screwed to the upper magnet holding portion 34. A part of the upper cover flange portion 36f overlaps the fixed flange portion 35f arranged in the flange housing recess 34p.

The lower cover 38 is located below the lower magnet holding portion 37. The lower cover 38 has a cylindrical shape centered on the central axis J. The lower cover 38 includes a lower cover cylindrical portion 38a, a lower cover bottom portion 38b, and a lower cover flange portion 38f.

The lower cover cylindrical portion 38a a has a cylindrical shape extending in the axial direction with the central axis J as the center. The lower cover bottom portion 38b extends radially inward from the lower end of the lower cover cylindrical portion 38a. The lower cover cylindrical portion 38a has a plate shape along a plane orthogonal to the central axis J. A shaft insertion hole 38h through which the shaft 11 is inserted is provided at the center of the lower cover cylindrical portion 38a.

The lower cover flange portion 38f extends radially outward from the lower end of the lower cover cylindrical portion 38a. The lower cover flange portion 38f is screwed to the lower magnet holding portion 37. A part of the lower cover flange portion 38f overlaps the fixed flange portion 35f arranged in the flange housing recess 37p. That is, the shoulder bolt holding portion 35 is sandwiched between the lower magnet holding portion 37 and the lower cover 38 in the axial direction. Therefore, the lower shoulder bolt holding portion 35B is reliably held by the lower magnet holding portion 37 and the lower cover 38, similarly to the upper shoulder bolt holding portion 35A.

The upper cover 36 and the lower cover 38 cover the eccentricity sensor 70 and the shoulder bolt 50, respectively. As a result, the upper cover 36 and the lower cover 38 can protect the eccentricity sensor 70 and the shoulder bolt 50, and suppress damage caused by collision with other members. In addition, the upper cover 36 and the lower cover 38 can suppress the shoulder bolt 50 from coming into contact with other members and moving in the axial direction. The operation of the shoulder bolt 50 is performed after removing the upper cover 36 and the lower cover 38.

### (Shoulder Bolt)

The shoulder bolt 50 has a shaft portion 50b and a head portion 50c. The shaft portion 50b extends in the axial direction with the central axis J as the center. A male screw 50p is provided on the outer peripheral surface of the shaft portion 50b. The male screw 50p is inserted into the screw hole 35h of the shoulder bolt holding portion 35. Thus, the shoulder bolt 50 is held by the shoulder bolt holding portion 35. The shoulder bolt 50 axially moves with respect to the shoulder bolt holding portion 35 with rotation of the shaft portion 50b.

The head portion 50c is disposed at one end of the shaft portion 50b. The head portion 50c extends in a flange shape radially outward from the outer peripheral surface of the shaft portion 50b. The outer peripheral surface of the head portion 50c has a hexagonal shape when viewed from the axial direction. The head portion 50c is provided to rotate the shoulder bolt 50 using a spanner or the like.

The shoulder bolt 50 has an opposing surface 50a located at the tip of the head portion 50c and facing the axial direction. The opposing surface 50a of the upper shoulder bolt 50A faces downward. On the other hand, the opposing surface 50a of the lower shoulder bolt 50B faces upward. The opposing surface 50a faces the stepped surface 15b of the rotor 10 in the axial direction.

The rotor 10 of the present embodiment is held in the axial direction with respect to the stator 20 by a field current caused to flow through the coil 21 of the stator 20. The rotor 10 is not held in the axial direction before the rotary electric machine 1 is started. Therefore, the rotor 10 is supported in a state of being biased to one side in the axial direction by the magnetic force of the magnetic bearing 40 and the gravity. The rotor 10 before being started is supported by the housing 30 in either a state where the upper stepped surface 15b is in contact with the opposing surface 50a of the upper shoulder bolt 50A or a state where the lower stepped surface 15b is in contact with the opposing surface 50a of the lower shoulder bolt 50B.

The shoulder bolt 50 of the present embodiment moves in the axial direction with respect to the housing 30 by being rotated. In the rotary electric machine 1 before being started, when one shoulder bolt 50 in contact with the stepped surface 15b of the rotor 10 is moved in the axial direction, the rotor 10 moves in the axial direction together with the shoulder bolt 50.

If the rotor 10 is not disposed within a range of a specific position (floatable range) in the axial direction, the supporting force applied from the stator 20 to the rotor 10 at the time of start cannot float the rotor 10.

According to the present embodiment, it is possible to move the rotor 10 to be in the floatable range by moving the shoulder bolt 50. That is, the position before the start of the rotor 10 can be adjusted according to the individual difference of the magnetic force of the first magnet 16 and the second magnet 17, and the rotary electric machine 1 can be smoothly started regardless of the individual difference of the first magnet 16 and the second magnet 17.

The shoulder bolt 50 is provided with a central hole 50h penetrating in the axial direction. The central hole 50h extends in the axial direction about the central axis J. The shaft 11 passes through the central hole 50h. The central hole 50h is provided with a small-diameter portion 50s having a small inner diameter at the axial center of the shoulder bolt. The gap between the inner peripheral surface of the central hole 50h and the outer peripheral surface of the shaft 11 is the narrowest in the small-diameter portion 50s.

According to the present embodiment, since the shaft 11 passes through the central hole 50h of the shoulder bolt 50, it is possible to suppress the inclination of the shaft 11 from becoming too large due to the interference between the inner surface of the central hole 50h and the shaft 11.

The central hole 50h of the present embodiment narrows the gap with the shaft 11 in the small-diameter portion 50s. Therefore, when the rotor 10 is inclined at the time of overload or power failure, the shaft 11 and the small-diameter portion 50s come into contact with each other, so that it is possible to suppress contact between the stator core 22 and the first magnet 16 and the second magnet 17, and to avoid damage thereof. Furthermore, the gap between the inner peripheral surface of the small-diameter portion 50s and the outer peripheral surface of the shaft 11 may be narrower than the gap between the inner magnet 41 and the outer magnet 42 of the magnetic bearing 40. In this case, interference between the inner magnet 41 and the outer magnet 42 can be more reliably suppressed.

The central hole 50h of the present embodiment is provided with a large-diameter opening 50k that increases the inner diameter on one side in the axial direction. The large-diameter opening 50k has a circular shape centered on the central axis J when viewed from the axial direction.

### (Rotation Angle Sensor)

The rotation angle sensor 60 is located below the stator 20. The rotation angle sensor 60 detects the magnetic field of the second magnet 17 and measures the rotation angle of the rotor 10.

The rotation angle sensor 60 includes a substrate 61 extending along a plane orthogonal to the central axis J, a plurality of (six in the present embodiment) magnetic field detection elements (magnetic field detectors) 62 mounted on the substrate, a sensor holder 68 that covers and protects the substrate 61 and the magnetic field detection elements 62, and a connector 69 to which a harness terminal is connected.

The substrate 61 includes an annular portion 61a having an annular shape centered on the central axis J, an extending portion 61b extending radially outward from an outer edge of the annular portion 61a, and a terminal arrangement portion 61c located at the tip of the extending portion 61b. The annular portion 61a surrounds the shaft 11 from the radially outer side. Six magnetic field detection elements 62 are mounted on the annular portion 61a.

The annular portion 61a is disposed inside the housing 30. The extending portion 61b of the substrate 61 is disposed in the through hole 30h penetrating the outer peripheral surface of the housing 30. Therefore, the extending portion 61b extends across the inside and the outside of the housing 30. Further, the terminal arrangement portion 61c is arranged outside the housing 30. The connector 69 is mounted on the terminal arrangement portion 61c.

The magnetic field detection element 62 is, for example, a Hall element. The magnetic field detection element 62 is mounted on the upper surface of the substrate 61. The magnetic field detection element 62 extends upward from the substrate 61 in the axial direction. The six magnetic field detection elements 62 of the present embodiment are arranged at equal intervals along the circumferential direction. Tips of the respective magnetic field detection elements 62 are arranged between the second sub-tooth portions 24c arranged along the circumferential direction. The magnetic field detection element 62 faces the second magnet 17 in the radial direction. Each magnetic field detection element 62 detects the magnetic field of the second magnet 17.

According to the rotation angle sensor 60 of the present embodiment, the rotation angle of the rotor 10 is measured based on a change in the magnetic field of the second magnet 17. Therefore, it is not necessary to separately prepare a magnet for detecting the rotation angle, and the number of parts can be reduced.

### (Eccentricity Sensor)

The upper eccentricity sensor 70A is disposed near the upper end of the shaft 11. The lower eccentricity sensor 70B is disposed near the lower end of the shaft 11.

The upper eccentricity sensor 70A and the lower eccentricity sensor 70B detect radial displacements of the upper end and the lower end of the shaft 11. The upper eccentricity sensor 70A and the lower eccentricity sensor 70B measure the eccentricity of the shaft 11.

The eccentricity sensor 70 includes a sensor magnet 77 fixed to the rotor 10, and a sensor main body 76 fixed to the housing 30. The sensor magnet 77 and the sensor main body 76 face each other in the axial direction. In the upper eccentricity sensor 70A, the sensor main body 76 is located above the sensor magnet 77 and is fixed to the upper cover bottom portion 36b. In the lower eccentricity sensor 70B, the sensor main body 76 is located below the sensor magnet 77 and is fixed to the lower cover bottom portion 38b.

The sensor main body 76 includes a sensor substrate 71, a plurality of (four in the present embodiment) magnetic field detection elements (magnetic field detectors) 72, a first sensor cover 78, a second sensor cover 79, and a connector (not illustrated) to which a harness terminal is connected. The sensor substrate 71 extends along a plane orthogonal to the central axis J.

The magnetic field detection element 72 is mounted on the sensor substrate 71. The first sensor cover 78 covers and protects one surface of the sensor substrate 71. The second sensor cover 79 covers and protects the other surface of the sensor substrate 71 and the magnetic field detection element 72.

The sensor magnet 77 is fixed to the shaft 11. The sensor magnet 77 rotates around the central axis J together with the shaft 11. The sensor magnet 77 of the upper eccentricity sensor 70A is located at the upper end of the shaft 11 and above the upper shoulder bolt 50A. The sensor magnet 77 of the lower eccentricity sensor 70B is located at the lower end of the shaft 11 and below the lower shoulder bolt 50B.

The sensor substrate 71 has an annular shape centered on the central axis J when viewed from the axial direction. The sensor substrate 71 surrounds the shaft 11 from the radially outer side. The magnetic field detection element 72 is fixed to the housing 30 via the sensor substrate 71. The magnetic field detection element 72 is, for example, a Hall element. The magnetic field detection element 72 of the upper eccentricity sensor 70A is mounted on the lower surface of the sensor substrate 71. On the other hand, the magnetic field detection element 72 of the lower eccentricity sensor 70B is mounted on the upper surface of the sensor substrate 71.

The plurality of magnetic field detection elements 72 of the present embodiment are arranged at equal intervals along the circumferential direction. The magnetic field detection element 72 faces the sensor magnet 77 in the axial direction. The magnetic field detection element 72 detects the magnetic field of the sensor magnet 77. Since the eccentricity sensor 70 of the present embodiment includes the four magnetic field detection elements 72, the eccentricity of the shaft 11 can be measured with high accuracy. Further, according to the rotary electric machine 1 of the present embodiment, not only the positional deviation of the shaft 11 with respect to the central axis J but also the inclination of the shaft 11 can be three-dimensionally measured using the pair of eccentricity sensors 70.

(Control unit)

The control unit 90 is electrically connected to the stator 20, the rotation angle sensor 60, the upper eccentricity sensor 70A, and the lower eccentricity sensor 70B. Furthermore, the control unit 90 is connected to a power supply (not illustrated).

The control unit 90 and the stator 20 are connected by a power supply line. On the other hand, the control unit 90, the rotation angle sensor 60, the upper eccentricity sensor 70A, and the lower eccentricity sensor 70B are connected by signal lines. The control unit 90 controls the stator 20 on the basis of the measurement results received from the rotation angle sensor 60, the upper eccentricity sensor 70A, and the lower eccentricity sensor 70B.

The control unit 90 includes an inverter that converts the current supplied from the power supply into three-phase alternating current. The control unit 90 the control unit 90 controls the alternating current flowing through the coil 21, on the basis of the measurement result of the rotation angle of the rotor 10 in the rotation angle sensor 60. More specifically, the rotation speed of the rotor 10 is calculated from the measurement result of the rotation angle of the rotor 10, and the frequency of the alternating current flowing through the coil 21 is controlled.

### <Fabrication Method>

Next, a method of manufacturing the rotary electric machine 1 of the present embodiment will be described.

Here, in the method of manufacturing the rotary electric machine 1, a manufacturing procedure of the rotor 10 will be mainly described. The rotary electric machine 1 is manufactured by combining the rotor 10 with the stator 20 or the like that is fabricated by a conventionally known method.

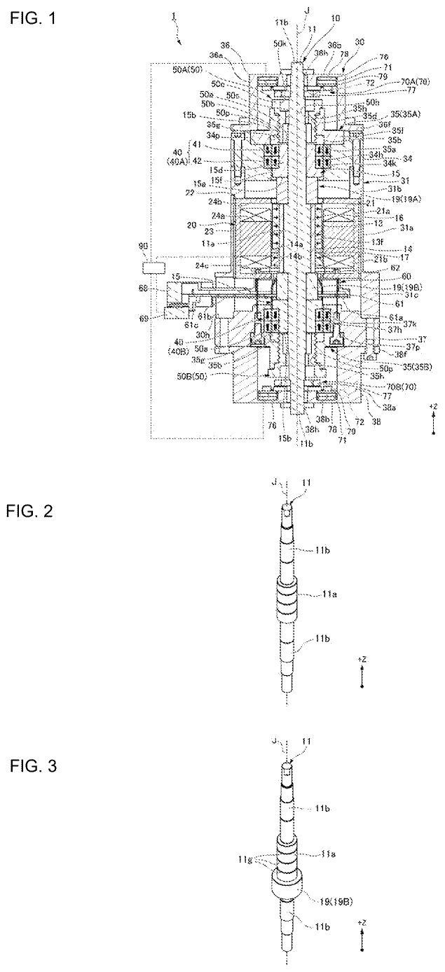

The method of manufacturing the rotary electric machine 1 includes at least a first spacer insertion step (FIG. 3), a rotor core insertion step (FIG. 4), an assembling step (FIGS. 5 to 7), a magnet fixing step, and a second spacer insertion step (FIG. 8). The rotor 10 of the rotary electric machine 1 is fabricated by sequentially assembling other members to the shaft 11 illustrated in FIG. 2.

The first spacer insertion step illustrated in FIG. 3 is a step of inserting the shaft 11 into the annular lower spacer 19B. The lower spacer 19B is mounted on the lower side of the large-diameter portion 11a of the shaft 11 from the lower end side of the shaft 11. The inner diameter of the lower spacer 19B is smaller than the outer shape of the large-diameter portion 11a. Therefore, the lower spacer 19B comes into contact with the lower end surface of the large-diameter portion 11a.

After the first spacer insertion step is performed, the shaft 11 and the lower spacer 19B are held using a jig (not illustrated). The rotor core insertion step, the assembling step, the magnet fixing step, and the second spacer insertion step, to be performed after the first spacer insertion step, are performed in a state where the shaft 11 and the lower spacer 19B are held by the jig.

In the rotor core insertion step illustrated in FIG. 4, the shaft 11 is inserted into the through hole 13h of the rotor core 13 and disposed and fixed on the upper side of the lower spacer 19B. The rotor core 13 is mounted on the large-diameter portion 11a of the shaft 11 from the upper end side of the shaft 11. The lower end surface of the rotor core 13 is brought into contact with the upper end surface of the lower spacer 19B. As a result, the lower end surface of the rotor core 13 and the lower end surface of the large-diameter portion 11a can be arranged on the same plane.

In the rotor core insertion step, an adhesive (not illustrated) is applied in advance to the outer peripheral surface of the large-diameter portion 11a of the shaft 11. The adhesive is cured after the rotor core 13 is mounted on the outer peripheral surface of the large-diameter portion 11a to fix the shaft 11 and the rotor core 13 to each other. As illustrated in FIG. 3, a plurality of recessed grooves 11g extending along the circumferential direction are provided on the outer peripheral surface of the large-diameter portion 11a. In the recessed groove 11g, a part of the adhesive accumulates to secure the film thickness of the adhesive.

The assembling step includes a first procedure (FIG. 5) of assembling the second magnet 17 to the rotor core 13, a second procedure (FIG. 6) of assembling the shim 14, and a third procedure (FIG. 7) of assembling the first magnet 16. That is, the assembling step is a step of assembling the first magnet 16, the second magnet 17, and the shim 14 to the rotor core 13.

In the present specification, “assembling” means that members are temporarily fixed by determining a relative positional relationship without fixing the members.

Therefore, the “assembling step” in the present specification is a step of temporarily fixing the members using the magnetic force or the like.

In the assembling step, an adhesive is applied in advance to the outer peripheral surface 13f of the rotor core 13. The first magnet 16 and the second magnet 17 are fixed to the outer peripheral surface 13f of the rotor core 13 by the adhesive. In the present embodiment, a case where the adhesive is applied to the outer peripheral surface 13f of the rotor core 13 will be described, but the adhesive may be applied to the first magnet 16 and the second magnet 17 side.

The first procedure illustrated in FIG. 5 is a procedure of arranging the plurality of second magnets 17 on the outer peripheral surface 13f of the rotor core 13 along the circumferential direction. The second magnet 17 is attracted to the outer peripheral surface 13f of the rotor core 13 by its own magnetic force. An adhesive is applied to the outer peripheral surface 13f of the rotor core 13 in advance. An uncured adhesive layer is formed between the rotor core 13 and the second magnet 17.

The second procedure illustrated in FIG. 6 is a step of inserting the rotor core 13 into the annular shim 14.

The shim 14 is attached to the upper side of the second magnet 17 from the upper end sides of the shaft 11 and the rotor core 13.

The third procedure illustrated in FIG. 7 is a procedure of arranging the plurality of first magnets 16 on the outer peripheral surface 13f of the rotor core 13 along the circumferential direction. The first magnet 16 is attracted to the outer peripheral surface 13f of the rotor core 13 by its own magnetic force. An adhesive is applied to the outer peripheral surface 13f of the rotor core 13 in advance. Therefore, an uncured adhesive layer is formed between the rotor core 13 and the first magnet 16.

In the first procedure and the second procedure of the assembling step, the first magnet 16 and the second magnet 17 are arranged between the guide portions 13a adjacent to each other in the circumferential direction.

Thus, the first magnet 16 and the second magnet 17 can be easily positioned along the circumferential direction. In particular, in the assembling step of the present embodiment, it is preferable that the first magnet 16 and the second magnet 17 are each brought into contact with a surface of the guide portion 13a facing one side or the other side in the circumferential direction. As described above, by bringing the first magnet 16 and the second magnet 17 into contact with one surface in the circumferential direction, even when the dimensional accuracy of the first magnet 16 and the second magnet 17 along the circumferential direction is low, the relative positional accuracy in the circumferential direction of the first magnet 16 and the second magnet 17 arranged in the axial direction can be enhanced.

The magnet fixing step is a step of fixing the first magnet 16 and the second magnet 17 to the rotor core 13.

In the present embodiment, an adhesive is disposed in advance between the first magnet 16 and the second magnet 17, and the rotor core 13. Therefore, the magnet fixing step is a step of curing the adhesive. When the first magnet 16 and the second magnet 17 are fixed to the rotor core 13, the shim 14 sandwiched between the first magnet 16 and the second magnet 17 is also fixed to the rotor core 13.

In the present embodiment, the magnet fixing step is a step of waiting until the adhesive is cured. When the curing of the adhesive can be promoted by heating, the magnet fixing step may be fixing for heating the entire rotor 10. When the adhesive is an ultraviolet-curable adhesive, the magnet fixing step may be fixing by irradiating the adhesive with ultraviolet rays.

The rotor 10 of the present embodiment is provided with an adhesive at a plurality of places. More specifically, the rotor 10 is provided with not only an adhesive fixing the rotor core 13 and the magnets (the first magnet 16 and the second magnet 17) but also an adhesive fixing the shaft 11 and the rotor core 13. In the magnet fixing step, these adhesives at a plurality of places may be simultaneously cured.

The magnet fixing step is performed in a state where the plurality of first magnets 16 and the plurality of second magnets 17 are brought into contact with the opposite surfaces (that is, the upper surface 14a and the lower surface 14b) of the shim 14 respectively by attracting each other with their magnetic force.

Therefore, the gap between the first magnet 16 and the second magnet 17 can be fixed to the thickness of the shim 14, and the distance between the first magnet 16 and the second magnet 17 can be kept constant along the circumferential direction. As a result, the axial support force of the rotor 10 by the stator 20 can be stabilized.

In the present embodiment, the magnetization directions of the first magnet 16 and the second magnet 17 arranged in the axial direction via the shim 14 are reversed. Therefore, the first magnet 16 and the second magnet 17 attract each other in the axial direction.

According to the present embodiment, the fabrication process can be simplified by positioning the first magnet 16 and the second magnet 17 in the axial direction using the magnetic force and further fixing them in that state.

In the present embodiment, the assembling step is a step of assembling the first magnet 16 and the second magnet 17 to the outer peripheral surface 13f of the rotor core 13 via an uncured adhesive. The magnet fixing step is a step of solidifying the adhesive. In the present embodiment, an adhesive layer made of an adhesive is provided between the outer peripheral surface 13f of the rotor core 13 and the inner peripheral surfaces of the first magnet 16 and the second magnet 17. In the uncured state, the adhesive layer allows relative movement between the rotor core 13 and the magnet (the first magnet 16 or the second magnet 17). According to the present embodiment, in the assembling step, the first magnet 16 and the second magnet 17 move toward the shim 14 by their magnetic force and automatically come into contact with the surfaces on both sides of the shim 14. This eliminates the need for the operator to bring the first magnet 16 and the second magnet 17 closer to the shim 14, so that the fabrication process can be simplified.

In the present embodiment, the case where the fixing means between the rotor core 13 and the magnets (the first magnet 16 and the second magnet 17) is adhesion has been described. However, the fixing means between the rotor core 13 and the first magnet 16 and the second magnet 17 may be other means such as caulking.

The second spacer insertion step illustrated in FIG. 8 is a step of inserting the shaft 11 into the annular upper spacer 19A. The upper spacer 19A is mounted on the upper side of the large-diameter portion 11a of the shaft 11 from the upper end side of the shaft 11. The upper spacer 19A is in contact with the upper end surface of the large-diameter portion 11a.

In addition to the above steps, the method of manufacturing the rotor 10 further includes a step of fixing the inner magnet 41 and the magnet pedestal portion 15 to the shaft 11. The method of manufacturing the rotary electric machine 1 further includes a step of incorporating the rotor 10 inside the separately fabricated stator 20.

Through these steps, the rotary electric machine 1 can be manufactured. These procedures may be performed manually by an operator or may be performed by a fabrication device.

The order of the respective manufacturing steps described above is merely an example. For example, in the above-described embodiment, the case where the rotor 10 is manufactured in the order of mounting the first magnet 16, the shim 14, and the second magnet 17 to the rotor core 13, after mounting the rotor core 13 on the shaft 11, has been described. However, the rotor core 13 may be mounted on the shaft 11 after the first magnet 16, the shim 14, and the second magnet 17 are mounted on the rotor core 13.

Although the embodiment of the present invention and the modifications thereof have been described above, the respective configurations and combinations thereof in the embodiment and the modifications are merely examples, and therefore addition, omission, substitution, and other variations of the configurations can be made within the scope not departing from the gist of the present invention. Further, the present invention is not to be limited by the embodiment and the modifications thereof.

1. A method of manufacturing a rotary electric machine including a rotor centered on a central axis and a stator surrounding the rotor,
the method comprising:
an assembling step of assembling, to a rotor core extending in an axial direction with the central axis as a center, a plurality of first magnets arranged in a circumferential direction, a plurality of second magnets arranged in the circumferential direction on one side in the axial direction with respect to the first magnet, and a shim made of a non-magnetic material and located between the plurality of first magnets and the plurality of second magnets; and
a magnet fixing step of fixing the plurality of first magnets and the plurality of second magnets to the rotor core, wherein
magnetization directions of each of the plurality of first magnets and each of the plurality of second magnets are radial directions and are opposite to each other, and
the magnet fixing step is performed in a state in which the plurality of first magnets and the plurality of second magnets are brought into contact with surfaces on opposite sides of the shim by attracting each other with magnetic force of each of the plurality of first magnets and each of the plurality of second magnets.

2. The method of manufacturing a rotary electric machine according to claim 1, wherein
the assembling step is a step of assembling the plurality of first magnets and the plurality of second magnets on an outer peripheral surface of the rotor core via an adhesive in an uncured state, and
the magnet fixing step is a step of solidifying the adhesive.

3. The method of manufacturing a rotary electric machine according to claim 1, wherein
a plurality of guide portions in a rib shape, extending in an axial direction, and arranged in a circumferential direction are provided on an outer peripheral surface of the rotor core, and
in the assembling step, the plurality of first magnets and the plurality of second magnets are each disposed between the plurality of guide portions adjacent to each other in the circumferential direction.

4. The method of manufacturing a rotary electric machine according to claim 3, wherein
in the assembling step, each of the plurality of first magnets and each of the plurality of second magnets are brought into contact with a surface facing one side or another side in the circumferential direction of each of the plurality of guide portions.

5. The method of manufacturing a rotary electric machine according to claim 1, further comprising:
a first spacer insertion step of inserting a shaft into a first spacer in an annular shape;
a rotor core insertion step of inserting the shaft into a through hole of the rotor core and disposing and fixing the shaft on another side in the axial direction of the first spacer; and
a second spacer insertion step of inserting the shaft into a second spacer in an annular shape, and disposing the shaft on another side in the axial direction of the rotor core.

6. A rotary electric machine comprising a rotor centered on a central axis and a stator surrounding the rotor, wherein
the rotor includes:
a rotor core extending in an axial direction with the central axis as a center;
a plurality of first magnets fixed to the rotor core and arranged in a circumferential direction;
a plurality of second magnets fixed to the rotor core on one side in the axial direction with respect to the plurality of first magnets and arranged in the circumferential direction; and
a shim made of a non-magnetic material and located between the plurality of first magnets and the plurality of second magnets,
magnetization directions of each of the plurality of first magnets and each of the plurality of second magnets are radial directions and are opposite to each other,
the plurality of first magnets are in contact with a surface facing another side in the axial direction of the shim, and
the plurality of second magnets are in contact with a surface facing one side in the axial direction of the shim.

7. The rotary electric machine according to claim 6, wherein
a plurality of guide portions in a rib shape, extending in an axial direction, and arranged in a circumferential direction are provided on an outer peripheral surface of the rotor core, and
the plurality of first magnets and the plurality of second magnets are each disposed between the plurality of guide portions adjacent to each other in the circumferential direction.

8. The rotary electric machine according to claim 6, wherein
the stator includes a stator core and a coil,
the stator core includes:
a core back portion in an annular shape centered on the central axis;
a plurality of main tooth portions extending radially inward from the core back portion and arranged along the circumferential direction;
a plurality of first sub-tooth portions extending radially inward from the core back portion and disposed with a gap on another side in the axial direction of the plurality of main tooth portions; and
a plurality of second sub-tooth portions extending radially inward from the core back portion and disposed with a gap on one side in the axial direction of the plurality of main tooth portions,
the coil is wound around each of the plurality of main tooth portions, and includes a first coil end positioned on the other side in the axial direction of the main tooth portion and a second coil end positioned on the one side in the axial direction of the main tooth portion,
each of the plurality of first magnets faces the main tooth portion and the first coil end in the radial direction, and
each of the plurality of second magnets faces the second coil end in the radial direction.
